(19) United States
(12) Patent Application Publication
(10) Pub. No.: US 2012/0189761 A1
(43) Pub. Date: Jul. 26, 2012

(54) AQUEOUS SUSPENSION OF ACTIVATED CARBON AND METHODS OF USE

(75) Inventors: Philip Edward Pentland, Altona (AU); Abhinetiri Kumari Maharaj, Altona (AU); Anthony Gerard Flynn, Altona (AU)

(73) Assignee: EUREKA! AGRESEARCH PTY LTD, Altona, Victoria (AU)

(21) Appl. No.: 13/266,957

(22) PCT Filed: Apr. 28, 2010
(86) PCT No.: PCT/AU2010/000488

§ 371 Date: Apr. 13, 2012

(30) Foreign Application Priority Data
Apr. 28, 2009 (AU) 2009901788

(51) Int. Cl. B05D 7/00; B05D 5/00

(52) U.S. Cl. 427/4

(57) ABSTRACT

The invention relates to an aqueous concentrate for agricultural use for dilution and spray application to soil or plant material comprising at least about 25% by weight activated carbon and a method of greening turf using the composition.

This invention relates to concentrated aqueous suspensions of activated carbon and to their use in treating plants and in particular ground cover such as turf.

Concentrated aqueous suspensions of carbon can be diluted and sprayed onto grass or soil to remove or intercept organic pesticides or other deleterious organic compounds. Aqueous suspensions of carbon can also be applied to turf grass to create a greening effect.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

There is a need to provide aqueous suspensions of activated carbon with high carbon loadings. Attempts to increase the carbon loading using conventional formulation strategies leads to the development of excessively high viscosity and/or clumping (over time) in the formulation, and both these features prohibit the uniform spray application of the product.

### SUMMARY

In one aspect the invention provides an aqueous concentrate for agricultural use for dilution and spray application to soil or plant material comprising at least about 25% by weight preferably at least about 30%, and more preferably at least 40% by weight activated carbon and wherein the concentrate has a viscosity of no more than about 1200 centipoise.

In a further aspect the invention provides a method of treating plants or soil by dilution and spray application of the composition.

The invention also provides a method for making highly-loaded suspensions of activated charcoal in water comprising the steps of:
(a) forming a mixture comprising at least one surface active agent, water, and optionally a glycol and/or urea, with mixing;
(b) adding a first charge of activated carbon powder to the aqueous mixture with mixing;
(c) milling the mixture, for example with a ball mill or a bead mill or a disc mill to achieve a viscosity of no more than about 600 centipoise; and
(d) adding a further charge of activated carbon powder to the milled mixture, with further mixing.

The method may further comprise one or more further steps selected from:
(a) optionally milling the composition following addition of the further charge;
(b) optionally adding another charge of activated carbon powder after said further charge with mixing; and
(c) optionally adding at least one selected from the group consisting of water, surface active agent and anti-deposition agent or like agent following said adding a further charge of activated carbon with mixing to achieve a viscosity of no more than about 1200 centipoise.

The invention also provides a method for removing or intercepting deleterious organic components, comprising diluting and spraying an aqueous suspension of activated carbon onto soil or plant material.

The invention also provides a method for enhancing the green colour of turf comprising diluting a concentrate (for example using one part of concentrate per 4 parts water), and spraying the diluted concentrate of activated carbon onto soil or plants such as turf, preferably at an application rate in the range of about from 200 to about 3000 litres of diluted liquor per-hectare, more preferably from bout 500 to about 1000 litres/ha. Either a single spray application or multiple spray applications through a season may be used. On a per-hectare basis, from about 50 to about 600 kg of activated carbon per hectare may be applied, preferably from about 150 to about 300 kg/ha.

Throughout the description and the claims of this specification the word “comprise” and variations of the word, such as “comprising” and “comprises” is not intended to exclude other additives, components, integers or steps.

### DETAILED DESCRIPTION

The invention relates to an aqueous concentrate comprising activated carbon and its dilution and use in treating plants or soil by spray application. The aqueous activated carbon composition is particularly useful for treating ground cover such as turf.

“Activated carbon” also called activated charcoal or activated coal is a form of carbon that has been processed to make it extremely porous and thus to have a very large surface area available for adsorption or chemical reactions. A gram of activated carbon can have a surface area in excess of generally at least 500 m². Activated carbon does adsorb iodine very well and in fact the iodine number, mg/g, (ASTM D28 Standard Method test) is used as an indication of total surface area.

Plant material includes but is not limited to seed, seedlings or more mature plants.

Turf refers to grass or other fine plants with their matted roots filling the upper stratum of soil and includes lawn. Non-limiting examples of grasses commonly used in turf include Bluegrass, Bentgrass, Ryegrasses, Fescues, Zoysiagrass, Bermudagrass, St. Augustine grass, Bahiagrass, Centipedegrass, Carpetgrass, Buffalograss, Grama grass, Elytrigia repens (Couch Grass).

It is preferred that activated carbon have an iodine number of at least 300 mg/g, more preferably at least 500 mg/g and typically in the range of 500 to 1500 mg/g more preferably 500 to 1200 mg/g.

The term “turf” refers to a layer of earth covered with plant ground cover such as grass and a piece of such a layer cut from the soil and used to make a lawn.

The composition utilises a concentrate comprising at least about 25%, preferably at least about 30% by weight activated carbon in the aqueous concentrate. Preferably the aqueous concentrate composition comprises at least about 40% activated carbon, more preferably at least about 50% by weight activated carbon.

The viscosity of the aqueous activated carbon concentrate is no more than about 1200 centipoise. Preferably the viscosity of the concentrate is no more than about 800 centipoise. In one embodiment, the viscosity of the concentrate is at least about 400 centipoise and more preferably greater than about 500 centipoise. A particularly preferred viscosity is in the range 500 to 800 centipoise.

Throughout this patent, the term “viscosity” is taken to refer to the Brookfield viscosity using a #2 spindle at 5.0 rpm, and measured at 16 deg C.

In one preference, the density of the concentrate is greater than about 1.2 g/ml, more preferably greater than about 1.25 g/ml and even more preferably greater than about 1.3 g/ml/.

Preferably the activated carbon in the composition has an iodine index of at least about 300 mg/g, more preferably at least about 500, even more preferably at least about 700, yet more preferably at least about 900. The more a carbon is activated, the more it develops a large specific surface area and the greater its absorption capacity, and its iodine index.

The aqueous activated carbon composition will preferably comprise one or more conditioning agents that are dissolved in the aqueous phase, such as urea and/or a soluble material that acts as an anti-freeze. Urea may be present at 1% to 7% by weight in the final composition, more preferably at 2% to 5% by weight. Soluble material that acts as an antifreeze may comprise a glycol such as propylene glycols or other anti-freeze additives known to the art. In one preference, the anti-freeze agent may be present at 1% to 8% by weight of the final composition, more preferably at 2% to 5%.

The aqueous activated carbon composition will preferably comprise at least one surfactant such as those selected from the group of wetting agents, dispersing agents and/or stabilising agents. The composition of the invention may also comprise de-foaming agents. Such agents provide benefits such as increased milling speed, increased particle loading, decreased viscosity, decreased gel formation, and decreased free water content. Other benefits provided by such agents may include allowing water to displace air from internal and external hydrophobic surfaces, and facilitating the disintegration of aggregated moieties. The surfactants may be selected from the group of non-ionic and ionic surfactants.

Surfactants used as wetting agents may include but are not limited to salts of alkylbenzene sulphonates, alkyl sulphonates, alkyl sulphates, mono and di-alkylsulphosuccinates, alkylnaphthalene sulphonates, lignin sulphonates, ether carboxylates, alkylethersulphates, alkyletherphosphates, non-ionic surfactants including alkylpolysaccharides, alcohol ethoxylates and alkylphenolethoxylates. Examples of various commercially available wetting agents are given in WO2006071887 (Reduced Foam Dispersions and Formulations Therefor), the contents of which are incorporated by reference. Dispersing agents include but are not limited to salts of alkylnaphthalene sulphonate condensates, salts of alkylphenol condensates, salts of sulphonated lignins, salts of polyacid resin copolymers, salts of polyphenol formaldehyde resins, salts of polyarylether sulphates such as tristyrylphenolethoxylate sulphate salts, alkoxylated alkylphenols and alcohols and block copolymers of ethyleneoxide and propyleneoxide. More examples are given in WO2006071887.

In one embodiment the composition includes a surfactant which acts as the dispersing agent. Such agents may be present in the formulation at 2% to 20% by weight, and may be polymeric anionic surfactants or other agents. Examples of such agents include alkylnaphthalenesulfonate-formaldehyde condensate, more preferably a sodium alkylnaphthalenesulfonate-formaldehyde condensate such as Supragil MNS/25, provided by Rhodia of Brisbane, Australia. Preferably the alkylnaphthalenesulfonate-formaldehyde condensate is present in the concentrate of the invention at between 20 and 200 g/kg, more preferably between 50 and 150 g/kg. Another class of surface active agents are defoaming agents. Defoaming agents include silicone based de-foamers, perfluoroalkyl defoamers and acetylenic diol de-foamers. Other examples of de-foaming agents are given in WO2006071887.

In a preferred embodiment, at least one of the surfactants is relatively water-insoluble. In one embodiment, at least one of the surfactants is water-insoluble and has a HLB value of less than about 9. Even more preferably, at least one of the surfactants comprises a nonylphenol ethoxlate such as Teric N4 (a nonylphenol ethoxylate having an average of 4 ethoxy groups per mole, sold by Huntsman chemicals of Melbourne, Australia.

In one embodiment, the composition comprises an agent selected from the set comprising anti-deposition agents, anti-redeposition agents, anti-greying agents, de-flocculating agents. Many of such agents are used in the formulation of solid and liquid laundry powders, and act to prevent the adhesion of particulate material to a substrate. In one preference, said agent is selected from the set comprising polyphosphates, pyrophosphates, carboxlated proteins, carboxymethyl cellulose, polyacrylates, and polymethacrylates. More preferably said agent is a polyphosphate or pyrophosphate, even more preferably a potassium salt or a mixed salt comprising potassium. A particularly preferred agent is tetrasodium pyrophosphate, which may be present in the range of from 2% to 25% by weight of the final concentrate, preferably in the range of from 5% to 15%.

After application of the diluted concentrate to turf, the activated carbon particles contained therein need to be removable under the influence of rain or a water spray. The greening effect arising from the application of the diluted concentrate to turf may be established by comparing the original turf to turf that (a) has been treated with the diluted concentrate; (b) about 5 minutes after treatment, has been sprayed with water to remove the carbon from the green plant matter; and (c) has been left for a period of time after carbon removal, for example 3 days.

The invention also provides a method for removing or intercepting deleterious organic components, comprising spraying an aqueous suspension of activated carbon onto soil or plants or seed beds. The aqueous suspension of activated carbon may be made by taking a concentrated suspension of activated carbon and diluting said suspension in spray water.

The invention also provides a method for enhancing the green colour of turf comprising (preferably diluting a concentrate as described above) spraying an aqueous suspension of activated carbon onto turf at an application rate in the range of from 50 kg to 600 kg carbon/ha, pref 100 kg to 400 kg carbon/ha. In one preference, the aqueous suspension of activated carbon may be made by taking a concentrated suspension of activated carbon and diluting said suspension in spray water.

The invention will now be described with reference to the following examples. It is to be understood that the examples are provided by way of illustration of the invention and that they are in no way limiting to the scope of the invention.

### EXAMPLES

The following materials and equipment were used in the examples:

Activated charcoal powder, 99% sub 300 microns, iodine index greater than 800 mg/g, was provided by Redox of Melbourne Australia.

Teric N4, nonylphenol ethoxylate 4EO, provided by Huntsman, Melbourne Australia.

Antifoam was a silicone type material sold as Gensil 2030 by Rhodia of Brisbane, Australia.

Propylene glycol was provided by Redox of Melbourne Australia.

Urea was provided by Incitec/Pivot of Melbourne Australia.

Supragil MNS/25, sodium alkylnaphthalenesulfonate-formaldehyde condensate, manufactured by Rhodia.

Tetra Potassium Pyrophosphate (TKPP), provided by Albright and Wilson, Melbourne, Australia.

Dispersant mixer (Dispermat N1 made by VMA—Getzmann GMBH of Reichshof, W.Germany, serial no 12459092).

Dyno mill (WAB Dynomil, made by Willy A Bachofen of Basel, Switzerland Multi-lab, 89 kg, No 020420, built 2002).

### Example 1

### 500 g/l Activated Carbon Suspension

| | Amount | Amount | |
|---|---|---|---|
| Ingredient | (per 1 kg) | (g/L) | Function |
| Activated | 381.9 | 500.00 | Active |
| Charcoal | | | |
| Urea | 23.9 | 31.25 | Wetter |
| Supragil MNS/25 | 100.0 | 130.92 | Dispersant |
| Propylene Glycol | 28.0 | 36.66 | Antifreeze |
| Antifoam | 4.0 | 5.24 | Reduce Foam |
| Water | 415.2 | 543.60 | Continuous Phase |
| Teric N4 | 47.0 | 61.53 | Thickener/Dispersant |
| Total | 100.0 | 1309.20 | |

### Method of Preparation

1. 100.0 g Supragil MNS/25, 28.0 g propylene glycol, 4.0 g antifoam and 23.9 g urea were added to 415.2 g of tap water and stirred with a Dispermat mixer to form a brown solution.

2. 300 g of activated charcoal powder was gradually added to the brown solution resulting in a black suspension with a viscosity of 630 cP (spindle #2, 5.0 RPM, 16° C.).

3. The suspension was passed through a small Dyno mill under the following conditions:
Glass chamber, 0.8-1.0 mm beads, mill speed 1.0, pump speed 1.2, milling temperature 35° C.
The resulting milled suspension showed significantly lower viscosity (viscosity=60 cP).

4. 41.9 g of activated charcoal was added to the milled suspension, increasing the viscosity to 600 cP.

5. The suspension was milled again under the same milling conditions and its resulting viscosity was 210 cP.

6. The remaining 40 g of activated carbon was added to the suspension (viscosity=948 cP).

7. 47.0 g of teric N4 was added to the suspension and the suspension was then stirred to uniformity with a Dispermat mixer. The viscosity of the final suspension was 612 cP.

8. The specific gravity of the final suspension concentrate was 1.3092 g/ml and its pH when diluted to 1% w/v in tap water was pH=8.90 at 16.8° C.

### Example 2

| Ingredient | Amount (g/L) | Function |
|---|---|---|
| Activated Charcoal | 500.00 | Active 500 g/l |
| | | Activated Carbon |
| | | Suspension |
| Urea | 31.25 | Wetter |
| Supragil MNS/25 | 130.92 | Dispersant |
| Propylene Glycol | 30.0 | Antifreeze |
| Antifoam | 5.24 | Reduce Foam |
| Water | 450.0 | Continuous Phase |
| Tetra-potassium | 200.0 | |
| pyrophosphate | | |
| Total | 1347.41 | |

### Method of Preparation

1. 100.0 g Supragil MNS/25, propylene glycol, 4.0 g antifoam and urea were added to tap water and stirred with a Dispermat mixer to form a brown solution.

2. 300 g of activated charcoal powder was gradually added to the brown solution resulting in a black suspension.

3. The suspension was passed through a small Dyno mill under the following conditions:
Glass chamber, 0.8-1.0 mm beads, mill speed 1.0, pump speed 1.2, milling temperature≦35° C.
The resulting milled suspension showed significantly lower viscosity (viscosity=60 cP).

4. 41.9 g of activated charcoal was added to the milled suspension.

5. The suspension was milled again under the same milling conditions.

6. The remaining 40 g of activated carbon was added to the suspension.

7. Tetra-potassium pyrophosphate (a laundry detergent builder) and the suspension was then stirred to uniformity with a Dispermat mixer.

### Example 3

### Greening Study

50 g of concentrate made as described in example 1 was added to 200 g of tap water, and after mixing the dilute material was sprayed onto stressed couch grass showing yellow colour in patches. The application rates were 100 litres/ha and 200 litres/ha, and after application of the carbon, there was a uniform distribution of dark colouring throughout the treated turf. After 5 minutes, the carbon was washed from the leaves with water sprayed from a hose. This led to carbon being moved from the leaves into the root zone. 3 days late, the treated couch grass plots were compared with an untreated control. Both treated plots of couch grass were found to be uniformly green, whereas the untreated control continued to show yellow colour in patches.

### Example 4

Concentrate made up as in Example 2 was diluted by addition of 1 part to 4 parts of water with mixing and the dilute material was sprayed onto sports grounds. After 5 minutes the carbon was washed from the grass with water sprayed from a hose. The removal of the dark colour associated with carbon was more readily achieved than in Example 3. Three days later treated and untreated grass plots were compared. The treated grass plots were greener and were more uniformly coloured than the untreated plots.

1-20. (canceled)

21. A method for enhancing the green color of plants comprising:
providing an aqueous concentrate for agricultural use for dilution and spray application comprising at least about 25% by weight activated carbon and having a viscosity of no more than about 1500 centipoise;
diluting the concentrate; and
spraying the diluted concentrate of activated carbon onto plants.

22. A method according to claim 21 wherein the diluted concentrate is applied at a rate in the range of from about 50 to about 600 kg of activated carbon per hectare.

23. A method according to claim 21 wherein the diluted concentrate is applied at a rate in the range of from about 150 to about 300 kg of activated carbon per hectare.

24. A method according to claim 21 wherein the aqueous concentrate comprises at least 30% by weight of activated carbon based on the weight of the aqueous concentrate.

25. A method according to claim 21 wherein the activated carbon constitutes at least about 40% by weight of the aqueous concentrate.

26. A method according to claim 21 wherein the viscosity of the concentrate composition is in the range of from 400 to 800 centipoise.

27. A method according to claim 21 wherein the concentrate comprises 1-7% urea by weight of the concentrate composition.

28. A method according to claim 21 wherein the concentrate comprises 2-5% urea by weight of the concentrate composition.

29. A method according to claim 21 wherein the concentrate comprises a polymeric anionic surfactant.

30. A method according to claim 21 wherein the concentrate comprises an anionic surfactant which is a condensate of naphthalene sulfonate in an amount of from 2% to 20% by weight of the concentrate composition.

31. A method according to claim 30 wherein the polymeric anionic surfactant is present in an amount in the range of from 5% to 15% by weight based on the weight of the concentrate composition.

32. A method according to claim 21 wherein the concentrate composition comprises an agent selected from the set comprising anti-deposition agents, anti-redeposition agents and anti-greying agents.

33. A method according to claim 21 wherein the concentrate comprises an agent selected from the set polyphosphate, pyrophosphate, polyacrylate, polymethacrylate; salts thereof comprising potassium ions and carboxymethyl cellulose.

34. A method according to claim 21 wherein the concentrate comprises tetrapotassium pyrophosphate an amount in the range of from 2% to 25% by weight of the concentrate composition.

35. A method according to claim 21 wherein the plants are grasses.

36. A method according to claim 21 wherein the plants are grasses selected from the group consisting of Bluegrass, Bentgrass, Ryegrasses, Fescues, Zoysiagrass, Bermudagrass, St. Augustine grass, Bahiagrass, Centipedegrass, Carpetgrass, Buffalograss, Grama grass, Elytrigia repens (Couch Grass).

37. A method according to claim 21 wherein the activated carbon aqueous concentrate is prepared by a method comprising the steps of:
forming a mixture comprising at least one surface active agent, water, and optionally a glycol and/or urea, with mixing;
adding a first charge of activated carbon powder to the aqueous mixture with mixing;
milling the mixture to achieve a viscosity of no more than about 600 centipoise; and
adding a further charge of activated carbon powder to the milled mixture, with further mixing.

38. A method according the claim 37 further comprising one or more further steps selected from:
milling the composition following addition of the further charge;
adding another charge of activated carbon powder after said further charge with mixing; and
adding at least one selected from the group consisting of water, surface active agent and anti-deposition agent or like agent following said adding a further charge of activated carbon with mixing to achieve a viscosity of no more than about 1200 centipoise.

39. A method according to claim 38 wherein the anti-deposition or like agent is selected from the set comprising polyphosphates, pyrophosphates, carboxylated proteins, carboxymethyl cellulose, polyacrylates, and polymethacrylates.

40. A method according to claim 39 wherein the anti-deposition or like agent comprises tetrapotassium pyrophosphate.
